(19) United States
(12) Patent Application Publication
(10) Pub. No.: US 2001/0000287 A1
(43) Pub. Date: Apr. 19, 2001

(54) Combination of waste bag and device for supporting said waste bag

(76) Inventor: Frank S. Gabl, Prospect Heights, IL (US)

Correspondence Address: Thomas D. Paulius, VEDDER, PRICE, KAUFMAN & KAMMHOLZ, 222 North LaSalle Street, Suite 2600, Chicago, IL, 60601, US

(21) Appl. No.: 09/733,155

(22) Filed: Dec. 8, 2000

Related U.S. Application Data
(63) Continuation of application No. 09/065,920, filed on Apr. 24, 1998.

(51) Int. Cl. B60T 11/34; B65B 67/04

(52) U.S. Cl. 248/99; 303/33

(57) ABSTRACT

A continuous band is provided for insertion into the mouth of a yard waste bag. The band is formed from a flexible material that permits it to be gripped at its center and squeezed into a collapsed position with two end loops having curved ends that will engage opposing sidewalls of the bag. In the collapsed position, the band presents a configuration of a partial lemniscate.

### BACKGROUND OF THE INVENTION

1. The present invention relates generally to devices for bags and, more particularly, to a device for maintaining yard waste bags in an open position to facilitate the loading thereof by a user.

2. Yard waste recycling has increased tremendously in the past few years. Many municipalities are requiring, by ordinance, that yard waste must be placed in biodegradable paper bags and set out at the side of a curb for collection by a special hauler. These paper bags serve as good receptacles for the yard waste which may comprise grass clippings, leaves, shrubbery and/or tree branches and other organic yard waste.

3. The paper bags used in these have a relatively large height of almost 36 inches or 3 feet. The cross-section of the bag is rectangular having spiral dimensions of about 12 inches by about 16 inches. The bags are typically folded up so that they may be sold in packets to users. When folded, the bags have dimensions of about 12 by 16 inches and have a thickness of about ½ inch. When so folded, the bags develop a “memory” that creates an unfortunate tendency for the bags to resume their folded condition. This proves extremely frustrating to users who unfold a bag and expect it to stand erect and open when filling it with yard waste. Often when filling a bag, some of the waste will catch on a side of the opening of the bag and will therefore cause the opening of the bag to collapse, further frustrating the user.

4. The present invention is therefore directed to a simple yard waste bag opening device that opens such a waste bag and maintains the mouth of the bag in an open position. There have been many approaches to solving the aforementioned frustrating problem. Although all of them appear as if they would work, their respective structures all appear to be overly complicated and they may have certain inherent disadvantage.

5. For example, U.S. Pat. No. 4,664,348 that issued May 12, 1987 describes a bag holder in the form of a flexible C-shaped member that is inserted into the bag mouth. The holder has two free ends that may rip into the bag walls and cause the bag walls at the bag mouth to rip and thereby defeat the purpose of the bag opening device.

6. U.S. Pat. No. 5,615,853 issued Apr. 1, 1997 describes a waste bag opening device that has a flexible strip with two free ends that are interconnected together by a string or cord. One end of this cord is knotted and extends through a hole in one end of the strip, while the other end of the cord extends through two holes. The cord is moved through these holes to adjust the configuration of the strip to form an outer support for a plastic bag. The cord may fray from repeated adjustment against the sides of the holes in the strip and therefore may break under repeated loading. The cord also is exposed in its extent along the bag opening and may break during loading of the bag.

7. Still other bag opening devices are large in size and bulky to manipulate and/or store, such as that described in U.S. Pat. No. 4,457,683 issued Jul. 3, 1984. The device described in this patent comprises a large, elongated planar sheet that is rolled up by the user to form a hollow cylinder that is inserted into the bag. Apart from requiring two hands to manipulate, this device is large and cumbersome to use and store when not in use.

8. Furthermore, other devices, such as that described in U.S. Pat. No. 5,082,219, which issued Jan. 21, 1992, require two hands to operate and cannot be manipulated with one hand. This device has an elongated belt with two sleeves formed at the ends of the belt that permit it to be adjusted in size. Although this structure is adjustable, it requires two hands to adjust it, thereby increasing its difficulty. Additionally, if grabbed in its mid portion, this device is likely to unexpectedly expand and frustrate its user.

9. Yet still other bag opening devices consist of articulated assemblies, that is, they include one or more segments that are united together by one or more associated joints. These joints render their devices non-continuous and hamper their ability to maintain a uniform opening pressure on the bag. They also may include sharp edges that could tear the bag walls, thus frustrating the bag user.

10. A need exists for a bag opening device that is continuous, has no joints, and that applies a constant and substantially opening pressure to the walls of a waste bag.

### SUMMARY OF THE INVENTION

11. The present invention is therefore directed to a device for opening trash waste bags and for holding such bags in an open position. In its broadest aspect, the device comprises a continuous band of flexible material thus has a diameter that is slightly larger than the length of the largest side of the bag mouth. The device may be formed, as exemplified by one embodiment of the present invention as a continuous, integral strip and as exemplified by another embodiment of the present invention as an elongated strip that is permanently fastened together by overlapping two ends to form a continuous band or ring. Thus, the present invention eliminates the need to provide a means for fastening the ends together.

12. The device has a width and thickness that renders it particularly flexible and which facilitates it handling and operation by a user with one hand, rather than with two hands and does not have to be adjusted to fit the opening of the bag. The band has an overall circular configuration that is different from the typical rectangular opening of a conventional paper yard waste bag. The circumference of the band is just about at least equal to and occasionally slightly greater than the perimeter of the bag mouth of the waste bag so that the band will exert an outward force on the bag walls. Due to the ring-like nature of the band, it will apply a uniform opening pressure on the bag opening that is not likely to cause the bag walls at the opening to rip.

13. In another important aspect of the present invention, the band is continuous and solid throughout its length without any joints or loose ends present that need to be adjusted. This continuous nature, along with the flexibility of the band material, permits the band to be grasped and squeezed together so that is adopts the configuration of a partial lemniscate with two opposing curved ends. These curved ends may be considered as loops which have no sharp edges and that will assist in opening the bag and its mouth.

14. These and other objects, features and advantages of the present invention will be clearly understood through consideration of the following detailed description.

### BRIEF DESCRIPTION OF THE DRAWINGS

15. In the course of the following detailed description reference will be frequently made to the accompanying drawings in which:

16. FIG. 1 is a perspective view of a yard waste bag in a folded condition;

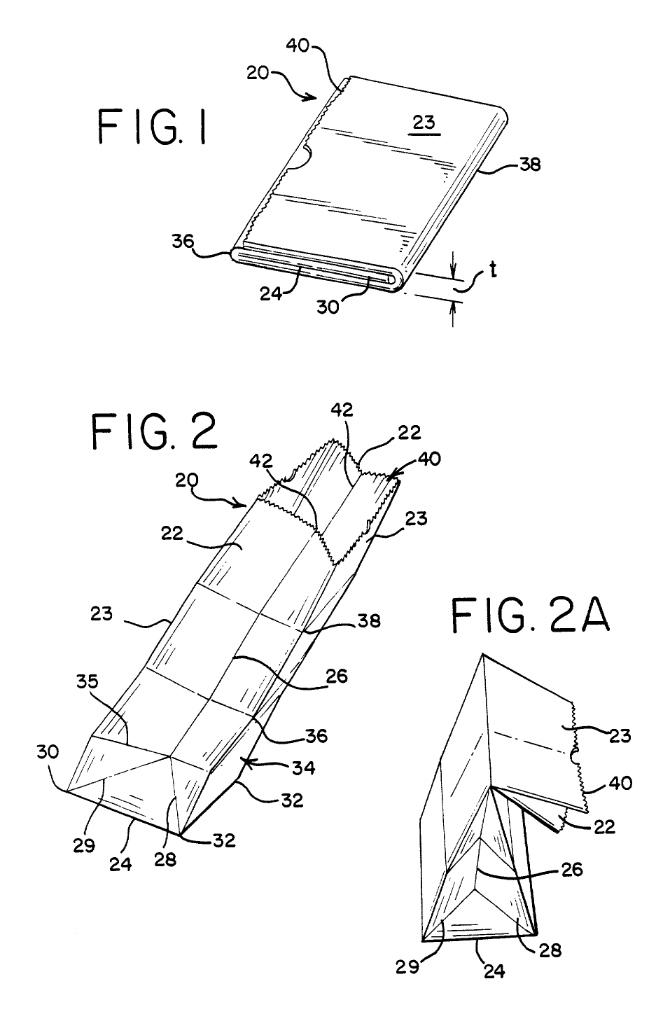

17. FIG. 2 is a perspective view of the yard waste bag of FIG. 1 in an unfolded, opened and erect condition;

18. FIG. 2A is the same view as FIG. 2, but illustrating the configuration of the bag after the bag has collapsed upon itself;

19. FIG. 3 is a perspective view of one embodiment of a bag device constructed in accordance with the principles of the present invention;

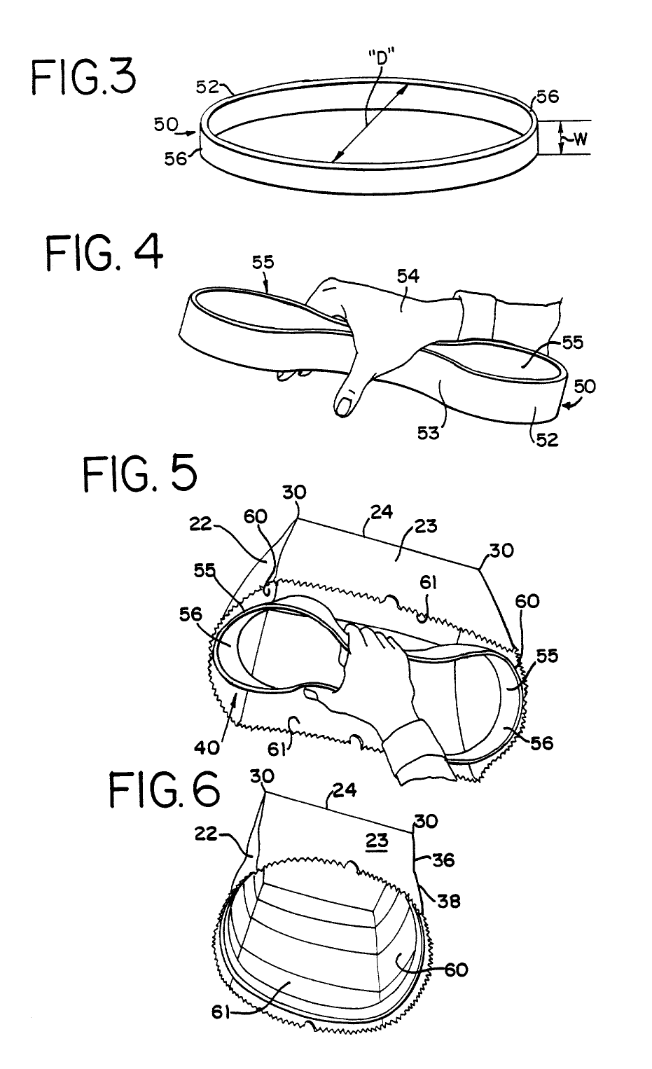

20. FIG. 4 is a side view showing how the bag device of FIG. 3 is gripped and placed into an insertion position by a user's hand;

21. FIG. 5 is a perspective view, illustrating how the bag device of FIG. 4 is inserted into the opening of the bag of FIG. 2;

22. FIG. 5A is a diagrammatic view of FIG. 5, illustrating how the configuration of the device changes from a circle to that of a partial lemniscate;

23. FIG. 6 is a perspective view of a waste bag taken from the end of the bag illustrating the bag device inserted therein and in an expanded condition at the mouth of the bag;

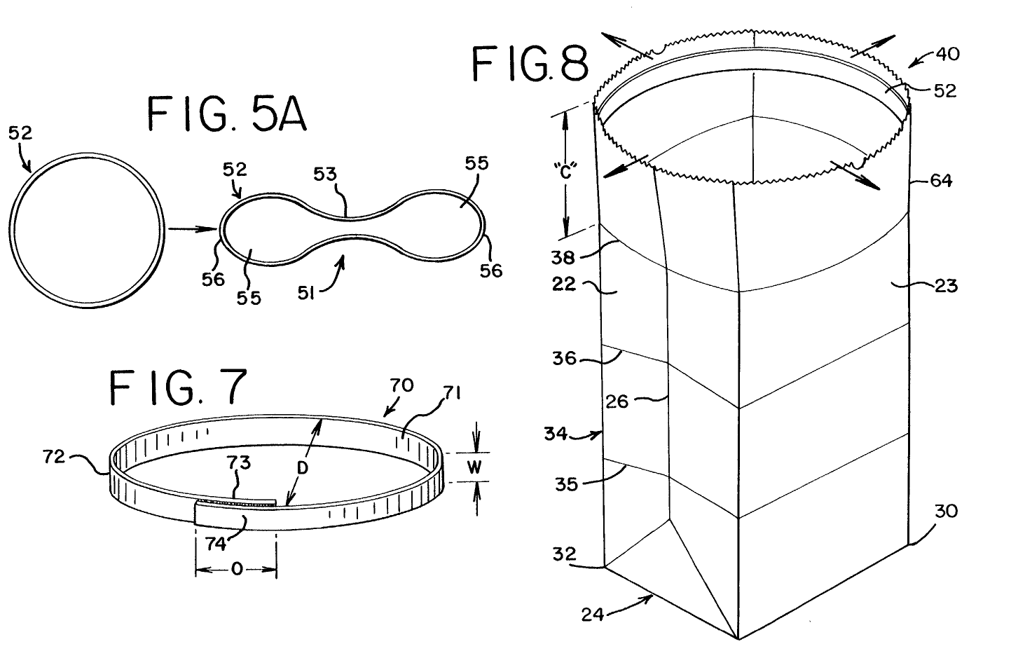

24. FIG. 7 is a perspective view of an alternate embodiment of a bag device constructed in accordance with the principles of the present invention; and,

25. FIG. 8 is a perspective view of a waste bag with the bag opening device of the present invention inserted in place at the bag mouth illustrating how the device supports the bag in an open position.

### DETAILED DESCRIPTION OF THE INVENTION

26. FIG. 1 illustrates a yard waste bag 20 in a folded condition that is typical of the state in which such waste bags 20 are purchased by consumers. FIG. 2 illustrates the waste bag 20 in an unfolded, opened and erect condition. It can be seen from FIG. 2 that the bag 20 has two pairs of sidewalls 22 & 23 that rise up from a bottom wall 24. These sidewalls 22 and 23 have a length of about 36 inches or so and each sidewall is folded upon itself along a center foldline 26 that run approximately for the height of the sidewalls. These center foldlines 26 split into two angled foldlines 28, 29 that extend to opposite corners 30, 32 of the bottom wall 24 of the bag 20. These foldlines 26, 28 & 29 and another transverse foldline 35 are utilized so that approximately the bottom third portion 32 of the bag 20 may easily be folded together and flat upon itself in a rectangular configuration having a thickness t of about ½-inch or less.

27. The waste bag 20 typically includes two other transverse folds 36 and 38 that are angularly displaced with respect to the sidewall center foldlines 36 and generally extend perpendicular thereto. These folds 34, 36 in effect, may be considered as separating the bag 20 into three vertical portions and also permit the bag to be folded twice upon itself for convenient packaging. The sidewalls 22, 23 of the bag cooperatively define at one end thereof, an open mouth 40 of the bag 20 through which a user may insert or pour yard, lawn or other waste.

28. Although these folds and foldlines are convenient for bag manufacturers for reducing the size of the bags 20 at their points of sale, they prove to be frustrating to a user of such bags 20. For example, the bag 20 is typically made of a biodegradable paper, such as kraft paper. The walls 22, 23 and 24 of the bag may be double ply or single ply. Although these plys are strong enough to hold a certain amount of waste without bursting, they are not strong enough to stand erect in an opened condition and, more often than not, the bag 20 when opened, stands slightly tilted on the ground as illustrated in FIG. 2.

29. Coincident with this tilting, another frustrating structural feature of the bag 20 occurs. The sidewalls 22 that have the center foldlines 26 formed therein tend to “bow” or “flex” inward because of their “memory”, especially near and at the bag mouth 40. It is believed that this occurs because the bag 20 does not have enough strength to support itself, but also because of the formed foldlines, both the foldlines 26, 28, 29 and 35 of the end sidewalls 22, but also the folds 36, 38 of the front and rear sidewalls 23 of the bag 20. All of these folds are mechanically made during construction of the bag 20 and they impart what I consider to be a “memory” to the bag 20.

30. This bowing or flexing problem results from these fold “memories” and they may frustrate the user of the bag 20 in that the end sidewalls 22 will form peaked, projecting portions 42 at the bag mouth 40 that we coincident with the center foldlines 26. These peaked portions 42 project into the opening at the bag mouth 40, when a user pours or clumps yard or other work into the bag mouth 40, it may catch on these peaked portions 42 and cause them and the bag mouth 40 to collapse. The bag 20 is illustrated in FIG. 2A in such a collapsed condition.

31. The present invention is directed to a simple device that may be easily inserted into the bag mouth 40 with one hand and that retains the bag mouth 40 in an open position without any adjustment, but also that eliminates the peaked portions 42 of the bag 20 or any other projections of the bag from extending into the area of the bag mouth 40.

32. One embodiment of such a device is illustrated generally as 50 in FIG. 3. This device 50 includes a continuous flexible bank 52 having a width W of about 2 inches for stability. The band 52 is preferably made from a flexible and solid, or imperforate material strip, such as plastic or formica or the like. In the embodiment illustrated in FIGS. 3-6, the band 52 may be made continuous through a suitable process, such as by injection molding. Such a band 52 may also be formed in a laminating or pressure forming process, wherein multiple, discrete ring layers are adhered to each other to form a continuous ring. Polyvinylchloride (“PVC”) strips of above: 1/16-inch in thickness have been found to give desirable results in forming the continuous band 52.

33. The band 52 is flexible so that it may be easily gripped and squeezed to a constricted state, such as that illustrated in FIGS. 4 and 5 where the band 52 is gripped near the center portion 53 thereof by a user's hand 54 to form a compressed band having two relatively large loops 55 portions at its ends 56. The flexible and continuous nature of the band 52 importantly forms the loop portions 55 in such a manner that the ends 56 thereof present curved surfaces 58 that may initially engage the interior surfaces 60 of the sidewalls 22. The curved surfaces 58 do not present any sharp ends or edges as would an articulated device that is interconnected by engaging two free ends together as described in the prior art.

34. In an important departure from the prior art bag device, the continuous and flexible nature of the band 52 provides an important structural advantage. This advantage is illustrated in FIG. 5A, wherein it can be seen that the continuous band 52 has an initial circular configuration (at the left of FIG. 5A) that can be collapsed to a configuration that approximates a figure-eight or, a partial lemniscate 51 (at the right of FIG. 5A). As mentioned above, this partial lemniscate configuration permits the band 50 to be easily inserted into a bag mouth 40. Moreover, in this configuration, the ends 56 of the loop portions 55 formed by collapsing, or squeezing, the band 50, on gentle curves that do not present any sharp edges that may tear into the side walls 22 of the bag 20. In the articulated bag devices of the prior art, the joints will not permit the device to be so collapsed and easily inserted.

35. The continuous nature of the band 52 eliminates the need for the user to adjust the size of the band 52 with two hands in order to fit the bag mouth 40, which is a departure from the prior art device described U.S. Pat. No. 5,082,219 referred to earlier above. When a user grasps the device of the '219 patent in its mid-portion and tries to collapse it, the free ends of this device will move and the device will expand to a state larger than the bag 20 under an outward pressure force caused by the grasping of the device. In the present invention, the band 52 is continuous and it will not expand under grasping pressure.

36. Once inserted, the user releases his or her hand 54 from the band 50 so that it springs outwardly against the interior surfaces 60, 61 of the bag 20 at the bag mouth 40, as illustrated in FIG. 6. The normal configuration of the bag mouth 40 is rectangular (FIG. 2), ignoring the effects of the peaked projections 42. The circular configuration of the band 52 is retained by the band 52 and thereby impressed upon the bag 20 at its opening.

37. This changes the overall configuration of the bag 20 when erected. FIG. 8 illustrates the bag of FIG. 6 in such an upright position. As can be seen from FIG. 8, part of the upper third portion 64, and particularly, the extent “C” now takes a cylindrical shape while the remaining middle and bottom third portions 65, 34 retain their rectangular shape. The outward flexing caused by the band 52 places a tension on the bag sidewalls 22, 23 which in turn, substantially prevents them from bowing or otherwise buckling in along any associated foldlines. The lower portions of the bag 20 that retain their rectangular shape permit the bag 20 to stand erect and to be stored when not in use without collapsing upon itself. The lower portions and the band 52 cooperate together to support the bag 20.

38. The cylindrical opening now formed in the bag 20 (FIG. 6) by the pressure of the band 52 permits the bag 20 to be laid on its side to facilitate the scooping or loading of debris into the bag opening 40. This cylindrical opening is an ideal, even opening without any sharp corners or edges that might restrict the user from quickly and easily depositing debris therein. Also, because the band 50 has an overall ring or hoop shape when expanded, it will in accordance with hoop or ring pressure theory, exert a uniform pressure on the bag sidewalls 22, 23 in a radially outwardly direction as represented by the arrows illustrated in FIG. 8. This pressure, in effect, overcomes the memory of the bag folds and enables the bag to stand erect as illustrated in FIG. 8.

39. In order to carry out this tensioning of the bag mouth 40, it is desirable that the perimeter, i.e, the circumference, of the band 52 be about the same size or slightly greater than the perimeter of the bag. Suitable ranges for the desirable circumference of the band 52 would be anticipated range about 98% to about 106% of the nominal perimeter of the bag mouth 40. Most waste bags 20 are produced having nominal dimensions of 12 inches by 16 inches but may have actual dimensions of about 12⅛ inches by 16⅛ inches. For such a bag 20, a band 50 having an overall general diameter of between about 17¾ inches and about 18 inches with a circumference of between about 55½ inches and about 56 inches or so yields desirable results. It will be understood that these dimensions are only exemplary for bags of associated dimensions and that the present invention is not to be limited to these particular dimensions. the band 52 will preferably be of a size that will exert a radially outward pressure on the walls 22, 23 of the bag 20 at the opening 40 thereof. It has been discovered that when the band 52 has dimensions that are greater than those of the bag opening 40, the band 52 will partially stretch the bag walls 22, 23. When this occurs and the band 53 is initially expanded against the sidewalls 22, 23 of the bag 20,, most of the band 52 will press against the sidewalls 22, 23, but a remaining portion will initially buckle inwardly and then “snap” into place against the bag walls 22, 23 when the bag stretching is effected.

40. FIG. 7 illustrated another embodiment of a continuous bag opening device 70 constructed in accordance with the principles of the present invention. This device 70 also includes a continuous band 71 that is formed from an elongated strip 72 that has two opposing ends 73, 74. The end portions 73, 74 are permanently joined together, such as by heat, plastics, ultrasonic or other type of welding or by way of a plastics adhesive or solvent when the base material of the band 71 is plastic. The end portions 73, 74 overlap a preselected distance O. No articulated joints or sharp edges are presented in this band 71. This type of band 52 is continuous in that the band ends 73, 74 are permanently joined together such that when the band 71 is either compressed or expanded, there is no relative movement between the band ends 73, 74 as would occur in non-continuous devices of the prior art.

41. While the preferred embodiment of the invention have been shown and described, it will be apparent to those skilled in the art that changes and modifications may be made therein without departing from the spirit of the invention, the scope of which is defined by the appended claims.

I claim:

1. A device for supporting a collapsible waste bag from the inside of the bag near a mouth of the bag for maintaining the bag mouth in an open position, the device comprising:
a continuous, imperforate band having an expanded circular configuration, the band being formed from a flexible material having sufficient flexibility that the band may be grasped by a user with one hand at approximately a mid-portion thereof and squeezed together with said one hand to form a collapsed configuration of a partial lemniscate to facilitate insertion of said band into said bag, said band expanding to said circular configuration when released and expanding radially outwardly against the bag.

2. The bag device as set forth in claim 1, wherein said band has an approximate circumference that is ranges from between about 100% to about 106% of the perimeter of said bag mouth.

3. The bag device as set forth in claim 1, wherein said band is formed from a solid strip of plastic.

4. The bag device as set forth in claim 1, wherein said band is formed from an elongated strip of plastic having two opposing ends, said band two ends being overlaid upon each other and permanently joined to each other to form said continuous band.

5. The bag device as set forth in claim 1, wherein said band has a width of between about 1 inch and about 2 inches.

6. The bag device as set forth in claim 2, wherein said band diameter is between about 17 and about 18 inches.

7. The bag device as set forth in claim 1, wherein said band, when grasped and squeezed with said one hand into said partial lemniscate, has two opposing end portions, each end including a partial loop with a curved surface facing outwardly at each said end portion.

8. The bag device as set forth in claim 4, wherein said band two ends are joined together by an adhesive.

9. The bag device as set forth in claim 4, wherein said band two ends are joined together by welding.

10. An expandable and collapsible device for imparting rigidity to a perimeter of an opening of a collapsible yard waste bag to facilitate the loading and unloading of the year waste bag, the device forming an interior frame of said bag opening, said device comprising:
a continuous, collapsible frame member that is configurable between a first configuration for expansion against said waste bag and a second, collapsed configuration for insertion into said yard waste bag opening, said first configuration being a circular configuration and said second configuration being a partial lemniscate, said band having a sidewall of predetermined width that engages an inner perimeter of said yard waste bag when said band is inserted into said yard waste bag and expanded against said yard waste bag sidewalls, said band being collapsible and expandable with one hand.

11. The device of claim 10, wherein said band, when in said partial lemniscate configuration, has two loop portions at opposite ends of said band, each of said loop portions having an exterior curved surface that initially contact said bag sidewalls when said band is inserted into said yard waste bag opening.

12. The device of claim 11, when said band includes an solid and imperforate band.

13. The device of claim 12, wherein said band has a circumference that is about 100% of said bag opening perimeter.

14. The device of claim 11, wherein said band has a circumference that is slightly greater than said perimeter of said bag opening, whereby when said band is expanded into said second configuration, said band exerts a pressure on said yard waste bag near said opening thereof.

15. The device of claim 11, wherein said band is formed from a solid strip of plastic.

16. The device of claim 11, wherein said band is formed from an elongated strip of plastic having two opposing ends that overlap each other and are joined together along the length in which they overlie each other.

17. A device for supporting a collapsible waste bag from the inside of the bag near a mouth of the bag for maintaining the bag mouth in an open position, the device comprising:
a continuous, non-articulated band having an expanded circular configuration, the band being formed from a flexible material having sufficient flexibility that the band may be grasped by a user with one hand at approximately a mid-portion thereof and squeezed together by said user with said one hand to form a collapsed configuration of a partial lemniscate to facilitate insertion of said band into said bag, said band expanding to said circular configuration when released and expanding radially outwardly against the bag, said band having an perimeter that is approximate no greater than a the perimeter of said bag mouth, said band, when in said partial lemniscate configuration, having two opposing end portions, each end including a partial loop with a curved surface facing outwardly at each said end portion.

18. The bag device as set forth in claim 17, wherein said band has an approximate circumference that is about 100% of the perimeter of said bag mouth.

19. The bag device as set forth in claim 17, wherein said band is formed from a solid strip of plastic.

20. The bag device as set forth in claim 17, wherein said band is formed from an elongated strip having two opposing ends that overlap each other and which are joined together permanently along the length in which they overlie each other.
